(19) United States
(12) Patent Application Publication
(10) Pub. No.: US 2011/0101081 A1
(43) Pub. Date: May 5, 2011

(54) Pre-Folded File Bottom Box Form and Method of Creating Same

(75) Inventors: Fred Dowd, Princeton, MA (US); Keith B. Perron, Methuen, MA (US)

(73) Assignee: Technology Container Corporation, Shrewsbury, MA (US)

(21) Appl. No.: 12/914,034

(22) Filed: Oct. 28, 2010

Related U.S. Application Data
(60) Provisional application No. 61/256,332, filed on Oct. 30, 2009.

(51) Int. Cl. B65D 5/28; B31B 1/26

(52) U.S. Cl. 229/193; 493/162

(57) ABSTRACT

A pre-folded file bottom box form, a method of creating the box form, and a box created from the form. The box form is created from a unitary blank of corrugated material that is die cut and creased so as to form a series of interconnected panels arranged in three rows that each include four panels. A first row has four panels that each end up in the box as a reinforcing end wall or sidewall panel; each of these panels are separated by a narrow gap. A middle row includes four panels that each end up in the box as a box end wall or sidewall panel; each of these panels is contiguous with one panel of the second row. There is a crease located between each of the middle row panels, and between each of them and the first row panel that is contiguous with it. A third row, coupled to the second row, includes first and second bottom panels and two end-wall reinforcing panels. The first and second bottom panels are each contiguous with one of the panels of the second row with a crease located between them. The end-wall reinforcing panels are contiguous with the first bottom panel with a crease located between each of them and the first bottom panel.

### CROSS-REFERENCE TO RELATED APPLICATION

This application claims the benefit of priority of U.S. Provisional Patent Application Ser. No. 61/256,332 filed on Oct. 30, 2009, the entire contents of which are expressly incorporated by reference herein.

### FIELD

The invention relates to boxes made from corrugated materials.

### BACKGROUND

File bottom record/archive file storage boxes are historically made in a fashion that requires a great deal of complex, manual assembly by the user. The existing state of the art “file bottom” style, in which the bottom is created from flaps as the box form is folded into a box requires more time and space than is desirable. File bottom style boxes present a flat bottom that is best suited for storage on shelving, while other file box designs such as the automatic bottom style boxes have creases in the bottom flap(s) that can catch on shelving, and thus typically are not well suited for use in situations in which the boxes are going to be stored on shelves.

There are two problems with the file bottom box design. For one, the design requires the user to read and follow fairly complex assembly instructions taking time and labor to put the box together. The second problem is that the file bottom box form (the intermediate form in which the blank has been partially folded and lies flat for shipping and storage, and is ready to be assembled into a functional box) is relatively large, as the panels that eventually form the bottom project from the panels that eventually form the sidewalls and thus increase the area of the form. The result is that substantial area needs to be devoted to shipping and storage of these box forms.

### SUMMARY

This disclosure relates to a file bottom box form that has a footprint when in the flat state (i.e., the box form before it is squared up and folded to form a box) that is reduced by 33%, providing a significant material handling and shipping savings.

Featured is a box form for use in creating a box for file storage and the like. The box form is made from a unitary blank of material. The box, when assembled from the box form, has four interconnected sidewalls that define an open storage volume between them. The sidewalls are typically each rectangular in shape, to define a generally rectangular prism-shaped storage volume.

In an embodiment the pre-folded file bottom box form is made from a blank made from corrugated material that is die cut and creased so as to form a series of interconnected panels arranged in three rows that each include four panels and that define four columns of three panels. There is a first row that includes four panels that each end up in the box as a reinforcing end wall or sidewall panel, each of the panels of the first row separated from one or two adjacent panels of the first row by a narrow gap. There is a middle row, contiguous with the first row, that comprises four panels that each end up in the box as a box end wall or sidewall panel, wherein each of the panels of the first row is contiguous with one panel of the second row with a crease located between each of the middle row panels, and a crease located between each of the middle row panels and the one first row panel that is contiguous with such middle row panel. There is a third row, coupled to the second row, that comprises first and second bottom panels and two end-wall reinforcing panels, the first and second bottom panels each contiguous with one of the panels of the second row with a crease located between each of the first and second bottom panels and the middle row panel that is contiguous to it, and the end-wall reinforcing panels contiguous with the first bottom panel with a crease located between each of the end-wall reinforcing panels and the first bottom panel.

Also featured is a pre-folded file bottom box form created from this blank, in which the two end-wall reinforcing panels of the third row are folded onto the first third-row bottom panel, and the first third row bottom panel is then folded onto the contiguous second row panel. The second third-row bottom panel is folded onto the contiguous second row panel. The blank is then folded along two fold lines defined by creases, one crease located between a first end panel of the second row and the second row panel contiguous to it, and the other crease located between a second end panel of the second row and the second row panel contiguous to it, such that the edges of the first and second end panels of the middle row overlap. The overlapping edges of the first and second end panels of the middle row are fixed together, for example using an adhesive, to create the completed form. The first third row bottom panel can be folded onto the contiguous second row panel and the second third-row bottom panel can be folded onto the contiguous second row panel at the same time, via a single fold along the intersection of the second and third rows.

Further featured is a box created from this pre-folded file bottom box form. The box can be created by expanding the box form to a generally rectangular shape, pushing the first bottom panel down such that it lies at right angles to the sidewalls and end walls, folding the two end-wall reinforcing panels up against the end-wall panels, pushing the second bottom panel down onto the first bottom panel to form a double thickness flat bottom to the box, folding two first row panels down over their contiguous second row panels to create triple thickness end walls, and folding the other two first row panels over their contiguous second row panels to create double thickness sidewalls.

Also featured is a method of creating a pre-folded file bottom box form made from a unitary blank of material. This method comprises the following steps:

a) providing a blank of corrugated material that is die cut and creased so as to form a series of interconnected panels arranged in three rows that each include four panels and that define four columns of three panels, wherein:
a first row comprises four panels that each end up in the box as a reinforcing end wall or sidewall panel, each of the panels of the first row separated from one or two adjacent panels of the first row by a narrow gap;
a middle row, contiguous with the first row, comprises four panels that each end up in the box as a box end wall or sidewall panel, wherein each of the panels of the first row is contiguous with one panel of the second row with a crease located between each of the middle row panels, and a crease located between each of the middle row panels and the one first row panel that is contiguous with such middle row panel; and
a third row, coupled to the second row, comprises first and second bottom panels and two end-wall reinforcing panels, the first and second bottom panels each contiguous with one of the panels of the second row with a crease located between each of the first and second bottom panels and the middle row panel that is contiguous to it, and the end-wall reinforcing panels contiguous with the first bottom panel with a crease located between each of the end-wall reinforcing panels and the first bottom panel

b) folding the two end-wall reinforcing panels of the third row onto the first third-row bottom panel;

c) folding the first third row bottom panel onto the contiguous second row panel;

d) folding the second third-row bottom panel onto the contiguous second row panel;

e) then folding the blank along two fold lines defined by creases, one crease located between a first end panel of the second row and the second row panel contiguous to it, and the other crease located between a second end panel of the second row and the second row panel contiguous to it, such that the edges of the first and second end panels of the middle row overlap; and

f) fixing together the overlapping edges of the first and second end panels of the middle row, for example using an adhesive, to create the completed form.

Also featured is a method of creating a pre-folded file bottom box form made from a unitary blank of material, comprising the following steps:

a) providing a blank of corrugated material that is die cut and creased so as to form a series of interconnected panels arranged in three rows that each include four panels and that define four columns of three panels, wherein:
a first row comprises four panels that each end up in the box as a reinforcing end wall or sidewall panel, each of the panels of the first row separated from one or two adjacent panels of the first row by a narrow gap;
a middle row, contiguous with the first row, comprises four panels that each end up in the box as a box end wall or sidewall panel, wherein each of the panels of the first row is contiguous with one panel of the second row with a crease located between each of the middle row panels, and a crease located between each of the middle row panels and the one first row panel that is contiguous with such middle row panel; and
a third row, coupled to the second row, comprises first and second bottom panels and two end-wall reinforcing panels, the first and second bottom panels each contiguous with one of the panels of the second row with a crease located between each of the first and second bottom panels and the middle row panel that is contiguous to it, and the end-wall reinforcing panels contiguous with the first bottom panel with a crease located between each of the end-wall reinforcing panels and the first bottom panel

b) folding the first and second third row bottom panels onto the contiguous second row panels;

c) then folding the blank along two fold lines defined by creases, one crease located between a first end panel of the second row and the second row panel contiguous to it, and the other crease located between a second end panel of the second row and the second row panel contiguous to it, such that the edges of the first and second end panels of the middle row overlap; and

d) fixing together with adhesive the overlapping edges of the first and second end panels of the middle row, to create the completed form.

Further featured is a box created from this pre-folded file bottom box form. The box may be created by expanding the box form to a generally rectangular shape, folding the two end-wall reinforcing panels of the third row onto the first third-row bottom panel, pushing the first bottom panel down such that it lies at right angles to the sidewalls and end walls, folding the two end-wall reinforcing panels from one side of the first bottom panel to the other, folding the two end-wall reinforcing panels up against the insides of the end-wall panels, pushing the second bottom panel down onto the first bottom panel to form a double thickness flat bottom to the box, folding two first row panels down over their contiguous second row panels to create triple thickness end walls and folding the other two first row panels over their contiguous second row panels to create double thickness sidewalls. The two end-wall reinforcing panels and the first bottom panel may be scored with a series of diagonal score lines to facilitate the folding of the two end-wall reinforcing panels from one side of the first bottom panel to the other.

### BRIEF DESCRIPTION OF THE DRAWINGS

Other features and advantages will be apparent from the following more particular description of embodiments as illustrated in the accompanying drawings in which like reference characters refer to the same parts throughout the different views. The drawings are not necessarily to scale, emphasis instead being placed upon illustrating the principles of the box form and the resulting box.

FIG. 1 shows a blank used to create an embodiment of the pre-folded file bottom box form.

FIG. 2 shows a partially folded blank of FIG. 1.

FIG. 3 shows a further folded blank of FIG. 2.

FIG. 4 shows a further folded blank of FIG. 3.

FIG. 5 shows a further folded blank of FIG. 4.

FIG. 6 shows a further folded blank of FIG. 5.

FIG. 7 shows a pre-folded file bottom box form created from the blank of FIG. 1.

FIG. 8 shows a blank used to create an embodiment of the pre-folded file bottom box form.

### DESCRIPTION OF EMBODIMENTS

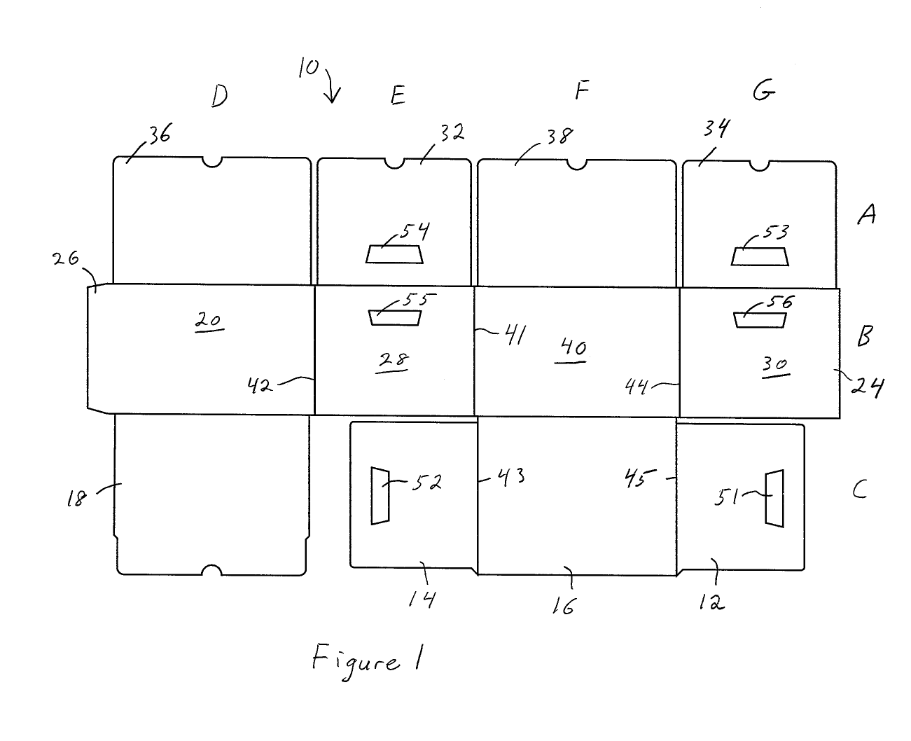

The embodiment shown in FIGS. 1-7 is formed from the unitary blank of material 10. Blank 10 may be constructed of any material that will form a stiff panel surface. Preferably, blank 10 is made from a single thickness corrugated material (corrugated paper or corrugated plastic); that is, a material with two layers of linerboard separated by a single layer of fluted material. Such a corrugated material can be constructed from different substances, as is known in the art. The material can have several different constructions. Corrugated material is typically constructed from fiber materials or plastic materials.

Blank 10 is an integral piece that is formed through die cutting and creasing of corrugated material as is known in the art. FIG. 1 shows the blank from the side that will form the inside of the box; the opposite side forms the outside of the box. Lines 41-45 indicate creases where the blank is adapted to be folded. Other creases between certain panels, shown as solid lines, are not numbered. To create the box form, blank 10 is pre-folded such that the panels that make up the bottom are overlayed over panels that make up the sidewalls. As a result, the form has an area that is only about two-thirds that of the typical form. This results in space savings in trucks, shipping containers and other means by which box forms are shipped, as well as warehouses, storage rooms, shelves and other locations where box forms are stored by distributors, retailers and/or end-users before the forms are folded into boxes.

Blank 10 defines three rows of panels labeled A, B and C, and four columns of panels labeled D, E, F and G: twelve panels in all. Blank 10 defines the panels via creased fold lines (indicated by solid lines that are not on the perimeter of blank 10) and in some cases gaps between adjacent panels that are created via die cutting. Panels 20, 28, 40 and 30 will form the box sidewalls and end walls. Panels 16 and 18 will form the bottom. Panels 12 and 14 become end-wall reinforcing panels, as do panels 32 and 34. Panels 36 and 38 become sidewall reinforcing panels. The box created from the form ends up with a double-thickness bottom, double thickness sidewalls (the long sides of the box) and triple-thickness end walls (the short sides of the box).

Panels 16 and 18 will form the bottom of the box, with panel 16 on the outside. Since panel 16 does not have any folds or creases in it, the resulting box will sit flat on shelves or other storage locations and is easier to handle than other boxes such as the automatic bottom style boxes in which the bottom panel has folds or creases in it and so does not present a flat outer surface.

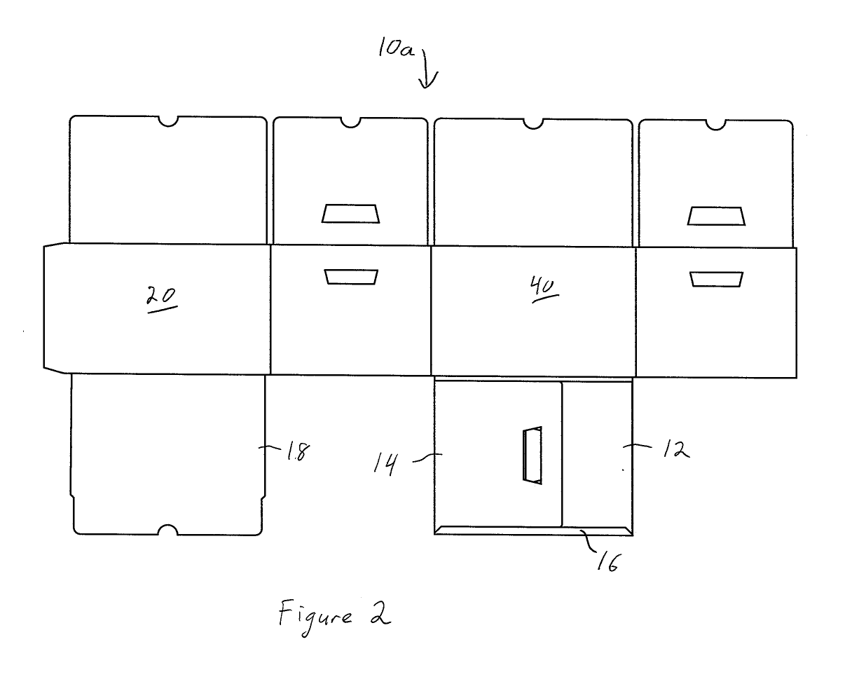

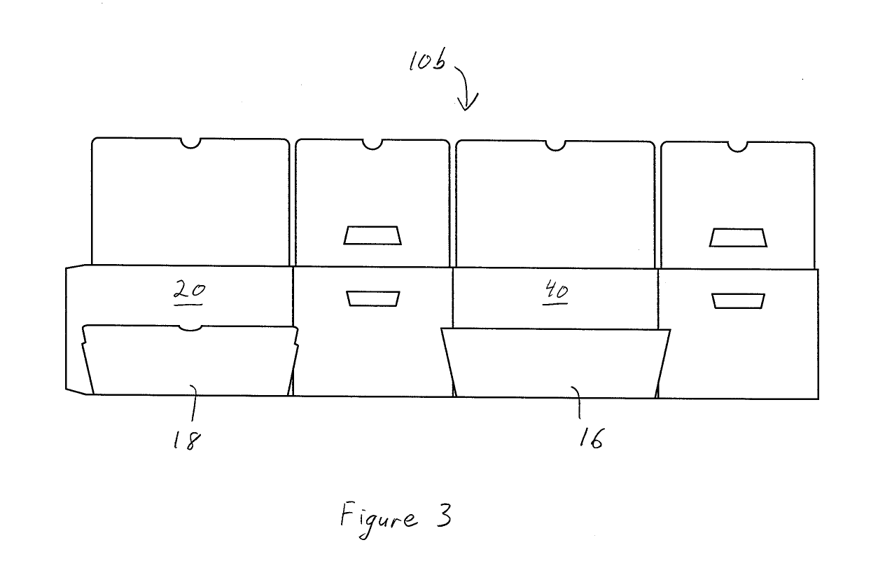

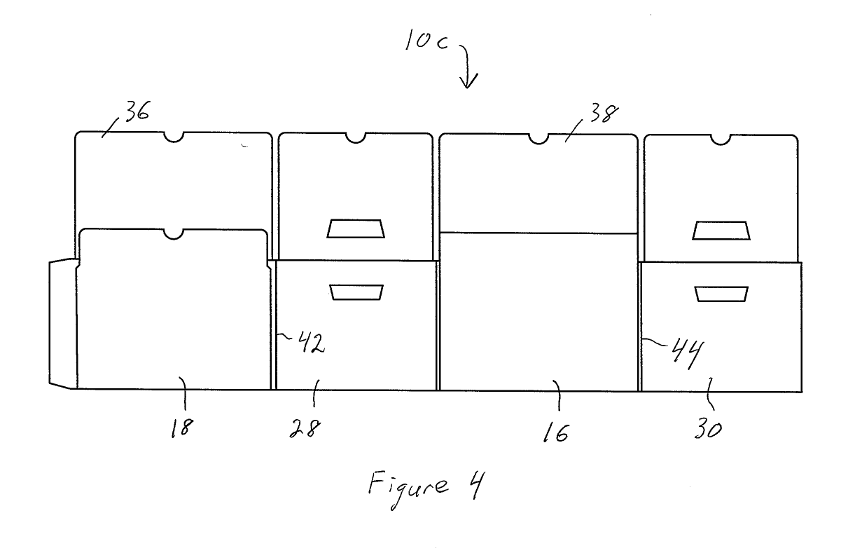

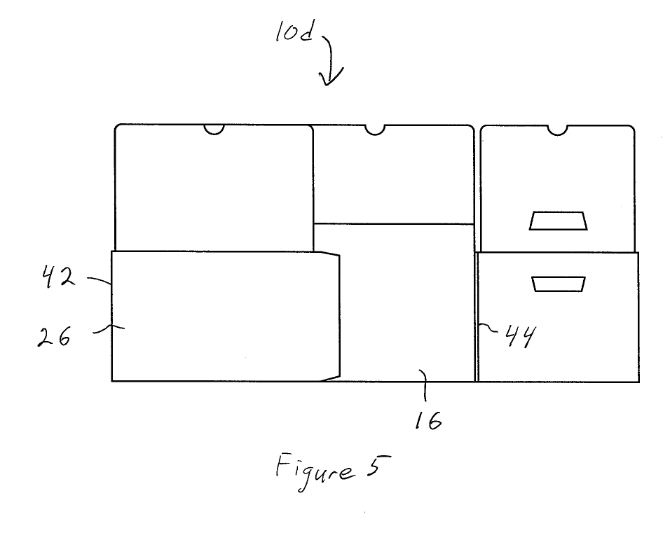

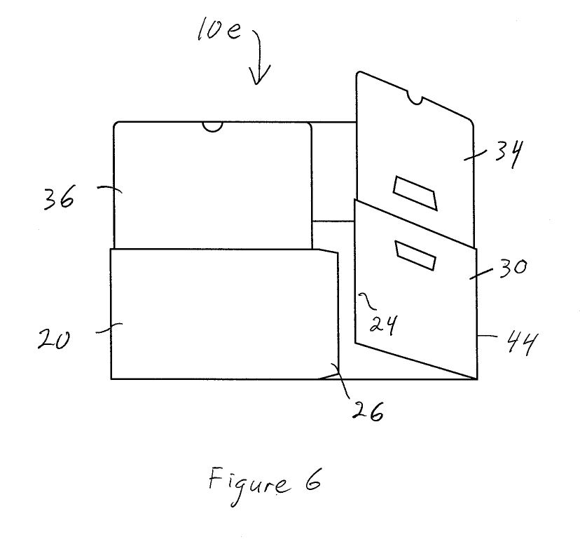

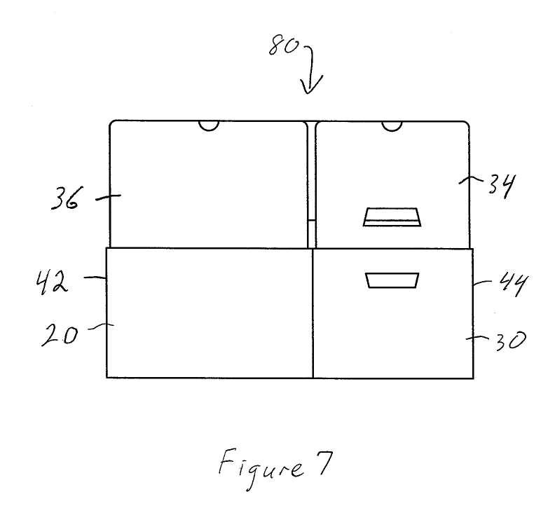

The pre-folded file bottom box body form 80, FIG. 7, is created from blank 10 as follows. Beginning with unfolded flat blank 10 (as it is shown in FIG. 1), panels 12 and 14 are folded onto panel 16 to create partially-folded form 10a, FIG. 2. Then panel 16 is folded onto panel 40 and panel 18 is folded onto panel 20 as shown in partially-folded form 10b, FIG. 3. As a result, the four panels of row C are located on top of panels in row B, as shown by partially-folded form 10c, FIG. 4. Form 10c is folded along vertical fold line 42 to create partially-folded form 10d, FIG. 5 and then folded along fold line 44 to create partially-folded form 10e, FIG. 6. Area 24 of panel 30 is glued to the back side of area 26 of panel 20. This creates the pre-folded file bottom box form 80, FIG. 7. This flat box form only occupies an area equal to rows A and B and columns E and F.

This box form is then folded into a functional box as follows: Pre-folded file bottom box form 80 is squared up to form a rectangular shape; this causes folding along fold lines 41, 42 and 44. Panel 16 is then pushed down such that it lies at right angles to the four sidewalls. Panel 14 is folded up along crease 43 against panel 28. Panel 12 is folded up along crease 45 against panel 30. Panel 18 is then pushed down onto panel 16. This forms a double thickness flat bottom to the box. Panel 32 is then folded down over panel 14, and panel 34 is folded down over panel 12. This creates triple thickness end walls with handle panels 55 and 56 on the outside that communicate with handle openings 52 and 54, and 51 and 53, respectively. Longer sidewall panels 36 and 38 are then folded down over panels 20 and 40, respectively. This creates double thickness sidewalls along the two longer sides of the rectangular box.

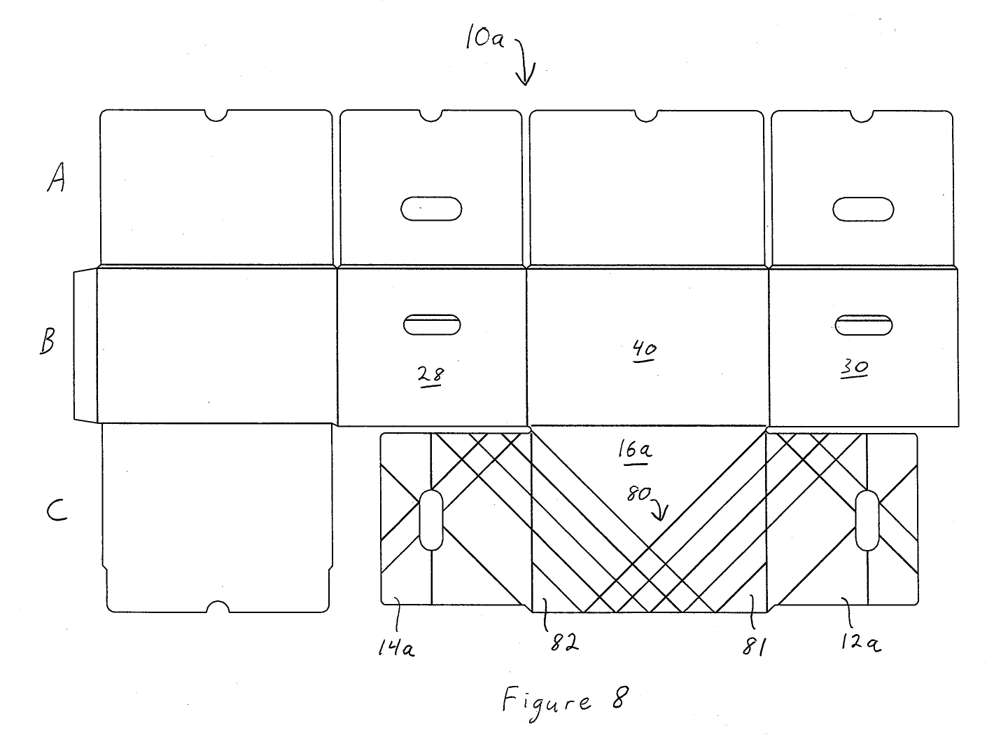

Another embodiment of a blank that is used to create a box body form that is assembled into a box is shown in FIG. 8. Blank 10a differs from blank 10 only in the diagonal score lines 80 (shown by solid black lines) in panels 12a, 14a and 16a (which differ from panels 12,14 and 16 only by the score lines). Blank 10a supports a different manner of creating the box form and a different manner of assembling the box from the box form.

In this embodiment the box form is created by folding row C onto row B without first folding panels 12a and 14a onto panel 16a. One reason to proceed in this manner is that in order to fold panels 12a and 14a onto panel 16a on an automated machine, additional folding equipment must be designed and installed on the machine. Since in both embodiments row C is folded onto row B, not first folding panels 12a and 14a onto panel 16a saves the cost of this additional equipment.

Once row C is folded onto row B, the box form is completed by adhering panel 26 to panel 24 as described above. Now, when the box is created from the form, after the form is squared up panels 12a and 14a are folded onto panel 16a so that panel 16a can be pushed down to its position at right angles to the sidewall panels. However, this leaves panels 12a and 14a on the wrong side of panel 16a: that is, panels 12a and 14a are on the outside of panel 16a rather than on the inside where they need to be in order to be folded against the inside of panels 30 and 28, respectively.

In order to correct the orientation of panels 12a and 14a, these panels must be reverse folded. The additional score lines on the three panels (12a, 14a and 16a) facilitate the folding and motions needed to move panels 12a and 14a into the inside of the box; the progressive diagonal scores allow the panels to be folded sufficiently for this procedure to take place.

To properly orientate panels 12a and 14a, panel 16a is held down and its corner 81 (the corner where it meets panel 12a) is bent upward towards the center of the box. This allows enough space for panel 12a to be bent on the series of scores and be rolled onto the other side of panel 16a, where it can then be folded up against the inside of panel 30. Once this operation has been completed, the same procedure is repeated for panel 14a, where corner 82 of panel 16a is lifted towards the center of the box and panel 14a is folded on the series of scores and rolled and folded into position first to the inside of panel 16a and then against panel 28.

Once panels 12a and 14a are in place against panels 30 and 28 respectively, panel 18 can be folded down into position over panel 16, forming a double strength bottom. The assembly of the box is then completed as described above, with panels 32, 34 36 and 38 being folded over to the inside of the box to complete the assembly of the body of the box.

The various aspects shown in some drawings and not others may be combined or used in other manners as would be apparent to those skilled in the art. The claims should not be read as limited to the described order or elements unless stated to that effect. Therefore, all embodiments that come within the scope and spirit of the following claims and equivalents thereto are claimed as the invention.

What is claimed is:

1. A blank for use in the creation of a pre-folded file bottom box form that is foldable into a box, comprising:
a unitary blank of corrugated material that is die cut and creased so as to form a series of interconnected panels arranged in three rows that each include four panels and that define four columns of three panels, wherein:
a first row comprises four panels that each end up in the box as a reinforcing end wall or reinforcing sidewall panel, each of the panels of the first row separated from one or two adjacent panels of the first row by a narrow gap;
a middle row, contiguous with the first row, comprises four panels that each end up in the box as a box end wall or sidewall panel, wherein each of the panels of the first row is contiguous with one panel of the second row with a crease located between each of the middle row panels, and a crease located between each of the middle row panels and the one first row panel that is contiguous with such middle row panel; and
a third row, coupled to the second row, comprises first and second bottom panels and two end-wall reinforcing panels, the first and second bottom panels each contiguous with one of the panels of the second row with a crease located between each of the first and second bottom panels and the middle row panel that is contiguous to it, and the end-wall reinforcing panels contiguous with the first bottom panel with a crease located between each of the end-wall reinforcing panels and the first bottom panel.

2. A pre-folded file bottom box form created from the blank of claim 1, wherein:
the two end-wall reinforcing panels of the third row are folded onto the first third-row bottom panel, and the first third row bottom panel is then folded onto the contiguous second row panel;
the second third-row bottom panel is folded onto the contiguous second row panel;
the blank is then folded along two fold lines defined by creases, one crease located between a first end panel of the second row and the second row panel contiguous to it, and the other crease located between a second end panel of the second row and the second row panel contiguous to it, such that the edges of the first and second end panels of the middle row overlap; and
the overlapping edges of the first and second end panels of the middle row are fixed together, to create the completed form.

3. The pre-folded file bottom box form of claim 2 wherein the overlapping edges of the first and second end panels of the middle row are fixed together with adhesive.

4. The pre-folded file bottom box of claim 2 wherein the first third row bottom panel is folded onto the contiguous second row panel and the second third-row bottom panel is folded onto the contiguous second row panel at the same time, via a single fold along the intersection of the second and third rows.

5. A pre-folded file bottom box form created from the blank of claim 1, wherein:
the first third row bottom panel is folded onto the contiguous second row panel;
the second third-row bottom panel is folded onto the contiguous second row panel;
the blank is then folded along two fold lines defined by creases, one crease located between a first end panel of the second row and the second row panel contiguous to it, and the other crease located between a second end panel of the second row and the second row panel contiguous to it, such that the edges of the first and second end panels of the middle row overlap; and
the overlapping edges of the first and second end panels of the middle row are fixed together, to create the completed form.

6. A box created from the pre-folded file bottom box form of claim 2.

7. The box of claim 6 created by:
expanding the box form to a generally rectangular shape;
pushing the first bottom panel down such that it lies at right angles to the sidewalls and end walls;
folding the two end-wall reinforcing panels up against the end-wall panels;
pushing the second bottom panel down onto the first bottom panel to form a double thickness flat bottom to the box;
folding two first row panels down over their contiguous second row panels to create triple thickness end walls; and
folding the other two first row panels over their contiguous second row panels to create double thickness sidewalls.

8. A method of creating a pre-folded file bottom box form made from a unitary blank of material, comprising:
a) providing a blank of corrugated material that is die cut and creased so as to form a series of interconnected panels arranged in three rows that each include four panels and that define four columns of three panels, wherein:
a first row comprises four panels that each end up in the box as a reinforcing end wall or reinforcing sidewall panel, each of the panels of the first row separated from one or two adjacent panels of the first row by a narrow gap;
a middle row, contiguous with the first row, comprises four panels that each end up in the box as a box end wall or sidewall panel, wherein each of the panels of the first row is contiguous with one panel of the second row with a crease located between each of the middle row panels, and a crease located between each of the middle row panels and the one first row panel that is contiguous with such middle row panel; and
a third row, coupled to the second row, comprises first and second bottom panels and two end-wall reinforcing panels, the first and second bottom panels each contiguous with one of the panels of the second row with a crease located between each of the first and second bottom panels and the middle row panel that is contiguous to it, and the end-wall reinforcing panels contiguous with the first bottom panel with a crease located between each of the end-wall reinforcing panels and the first bottom panel
b) folding the two end-wall reinforcing panels of the third row onto the first third-row bottom panel;
c) folding the first third row bottom panel onto the contiguous second row panel;
d) folding the second third-row bottom panel onto the contiguous second row panel;
e) then folding the blank along two fold lines defined by creases, one crease located between a first end panel of the second row and the second row panel contiguous to it, and the other crease located between a second end panel of the second row and the second row panel contiguous to it, such that the edges of the first and second end panels of the middle row overlap; and
f) fixing together the overlapping edges of the first and second end panels of the middle row, to create the completed form.

9. The method of claim 8 wherein the overlapping edges of the first and second end panels of the middle row are fixed together with adhesive.

10. The method of claim 8 wherein the first third row bottom panel is folded onto the contiguous second row panel and the second third-row bottom panel is folded onto the contiguous second row panel at the same time, via a single fold along the intersection of the second and third rows.

11. A box created from the pre-folded file bottom box form of claim 8.

12. The box of claim 11 created by:
expanding the box form to a generally rectangular shape;
pushing the first bottom panel down such that it lies at right angles to the sidewalls and end walls;
folding the two end-wall reinforcing panels up against the end-wall panels;
pushing the second bottom panel down onto the first bottom panel to form a double thickness flat bottom to the box;
folding two first row panels down over their contiguous second row panels to create triple thickness end walls; and
folding the other two first row panels over their contiguous second row panels to create double thickness sidewalls.

13. A method of creating a pre-folded file bottom box form made from a unitary blank of material, comprising:
a) providing a blank of corrugated material that is die cut and creased so as to form a series of interconnected panels arranged in three rows that each include four panels and that define four columns of three panels, wherein:
a first row comprises four panels that each end up in the box as a reinforcing end wall or reinforcing sidewall panel, each of the panels of the first row separated from one or two adjacent panels of the first row by a narrow gap;
a middle row, contiguous with the first row, comprises four panels that each end up in the box as a box end wall or sidewall panel, wherein each of the panels of the first row is contiguous with one panel of the second row with a crease located between each of the middle row panels, and a crease located between each of the middle row panels and the one first row panel that is contiguous with such middle row panel; and
a third row, coupled to the second row, comprises first and second bottom panels and two end-wall reinforcing panels, the first and second bottom panels each contiguous with one of the panels of the second row with a crease located between each of the first and second bottom panels and the middle row panel that is contiguous to it, and the end-wall reinforcing panels contiguous with the first bottom panel with a crease located between each of the end-wall reinforcing panels and the first bottom panel
b) folding the third row panels onto the contiguous second row panels;
c) then folding the blank along two fold lines defined by creases, one crease located between a first end panel of the second row and the second row panel contiguous to it, and the other crease located between a second end panel of the second row and the second row panel contiguous to it, such that the edges of the first and second end panels of the middle row overlap; and
d) fixing together with adhesive the overlapping edges of the first and second end panels of the middle row, to create the completed form.

14. A box created from the pre-folded file bottom box form of claim 13.

15. The box of claim 14 created by:
expanding the box form to a generally rectangular shape;
folding the two end-wall reinforcing panels of the third row onto the first third-row bottom panel;
pushing the first bottom panel down such that it lies at right angles to the sidewalls and end walls;
folding the two end-wall reinforcing panels from one side of the first bottom panel to the other;
folding the two end-wall reinforcing panels up against the insides of the end-wall panels;
pushing the second bottom panel down onto the first bottom panel to form a double thickness flat bottom to the box;
folding two first row panels down over their contiguous second row panels to create triple thickness end walls; and
folding the other two first row panels over their contiguous second row panels to create double thickness sidewalls.

16. The box of claim 15 wherein the two end-wall reinforcing panels and the first bottom panel are scored with a series of diagonal score lines to facilitate the folding of the two end-wall reinforcing panels from one side of the first bottom panel to the other.
